(19) United States
(12) Patent Application Publication
(10) Pub. No.: US 2004/0156598 A1
(43) Pub. Date: Aug. 12, 2004

(54) Pluggable optical transceiver module

(75) Inventor: Yu-Hong Shih, Nantou Hsien (TW)

Correspondence Address: WILLIAM B. PATTERSON, MOSER, PATTERSON & SHERIDAN, L.L.P., Suite 1500, 3040 Post Oak Blvd., Houston, TX, 77056, US

(73) Assignee: Delta Electronics, Inc.

(21) Appl. No.: 10/601,398

(22) Filed: Jun. 23, 2003

(30) Foreign Application Priority Data
Jan. 29, 2003 (TW) 92102058

(51) Int. Cl. G02B 6/36

(52) U.S. Cl. 385/92

(57) ABSTRACT

A pluggable optical transceiver module is described. The pluggable optical transceiver module has an optical fiber connecting interface, a transceiver, a golden finger connecting interface. The optical fiber connecting interface couples with an optical fiber to transmit optical signals to other devices. The transceiver transforms output electrical signals into output optical signals for delivery by the optical fiber connecting interface, and input optical signals into input electrical signals. The golden finger connecting interface transmits the output electrical signals and the input electrical signals of the pluggable optical transceiver module.

### BACKGROUND OF THE INVENTION

1. Field of the Invention

The present invention relates to a pluggable optical transceiver module and especially to a pluggable small form factor optical transceiver module

2. Background of the Invention

Computers have been widely applied in all fields and network technologies have rapidly progressed. Therefore, people can easily access information and provides service by way of networks. Due to the enormous data transmission capacity of optoelectronic communication devices, optoelectronic technology seems a likely candidate for improving transmission quality. Currently, the optoelectronic industry combining the electronics industry and the optics industry is progressing well. An important device is an optical transceiver module which includes an optical transmitter and an optical receiver, or an optical transceiver combining both functions.

The transmitter is capable of transforming electronic signals into optical signals and transmitting the same to an optical fiber. Classifications are made in accordance with the light source; the light source of the transmitter for optical fiber communication is mainly a light emitting diode (LED) or a laser diode. Since the laser diode has the advantages of high output power, fast transmission speed, small emission angle (i.e. a higher efficiency for coupling light source into an optical fiber), and narrower frequency spectrum (smaller dispersion), the laser diode is suitable for use in mid- or long-range transmission. While the LED has the advantages of low cost and simpler utilization (simpler driving and compensation circuits), an LED is suitable for use in short=range transmission. In particular, the laser diode, or semiconductor laser, has the advantages of small size, low power consumption, quick response, good collision resistance, long operation life, and high efficiency, so that the laser diode is very widely used in the application of optoelectronic products.

The main function of optical receiver is to convert an optical signal to an electronic signal, of which the most critical component is a detector. The major principle of the detector is to generate enough energy by radiating light onto a photo diode to excite pairs of electrons and holes, thereby generating a current signal.

The optical fiber is widely used in networks, and local area networks are increasingly constructed from optical fibers. But the high optoelectronic communication device price is an entrance barrier for the use of optical fiber networks. A small form factor (SSF) optical fiber network reduces the size of the transceiver modules and connectors. The SSF optical transceiver module has a compact volume of about half the conventional volume. A standard SSF transceiver module is around 0.5 inches wide. Compared with the foregoing generation product, which is around 1 inch wide, a designer can put more than twice as many modules in the same area of a printed circuit board. Therefore, the density of the input and output ports can increase so as to reduce a total system cost thereof.

FIG. 1 is schematic perspective view of a conventional optical transceiver module. A conventional optical transceiver module 100 uses pins 110 to connect with a printed circuit board. Therefore, a user needs to open the appliance cover and use a soldering tool to remove the optical transceiver module 100 and relative parts thereof, if the optical transceiver module 100 is malfunctioning or the user wants to replace the optical transceiver module 100 with another type of transceiver module. The replacement process is too complicated and therefore reduces the exchangeability of the optical transceiver module.

Therefore, there is a need to enhance exchangeability of the optical transceiver module and compatibility of the optoelectronic component.

### SUMMARY OF THE INVENTION

It is an object of the present invention to provide a pluggable transceiver module to enhance the compatibility and exchangeability thereof so as to simplify a replacement process for repairing and switching.

To accomplish the above objectives, the present invention provides a pluggable optical transceiver module. The pluggable optical transceiver module includes an optical fiber connecting interface, an optical signal transceiver, and a golden finger connecting interface. The optical signal transceiver can be replaced by an optical signal transmitter or an optical signal receiver. The optical fiber connecting interface connects with an optical fiber to transmit optical signals to other devices. The optical signal transmitter transforms output optical signals into output electronic signals and outputs the output electronic signals by way of the optical fiber connecting interface. The optical signal receiver transforms input optical signals into input electronic signals. The optical signal transceiver can perform functions of both the optical signal transmitter and receiver. The golden finger connecting interface transmits the input and output electronic signals for an electronic appliance with the pluggable optical transceiver module according to the present invention.

The golden finger connecting interface uses the printed circuit board technology to print golden fingers directly on a circuit board. The optical signal transmitter further comprises a laser diode and the optical signal receiver comprises a photo diode.

The electric appliance with the pluggable optical transceiver module according to the present invention further comprises a corresponding socket to couple with the golden finger connecting interface.

The pluggable optical transceiver module according to the present invention is preferably used with a single channel bi-direction small form factor optical transceiver module to enhance the compatibility thereof.

Hence, the present invention effectively enhances the compatibility of the optical transceiver module so that the interchangeability, repairing ability and switching ability of pluggable optical transceiver module according to the present invention are improved.

### BRIEF DESCRIPTION OF THE DRAWINGS

The foregoing aspects and many of the attendant advantages of this invention are more readily appreciated as the same becomes better understood by reference to the following detailed description, when taken in conjunction with the accompanying drawings, wherein:

FIG. 1 is a schematic perspective view of a conventional optical transceiver module; and

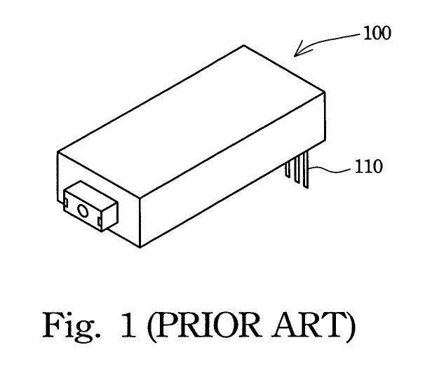

FIG. 2 is an optical transceiver module installed in an electric appliance according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

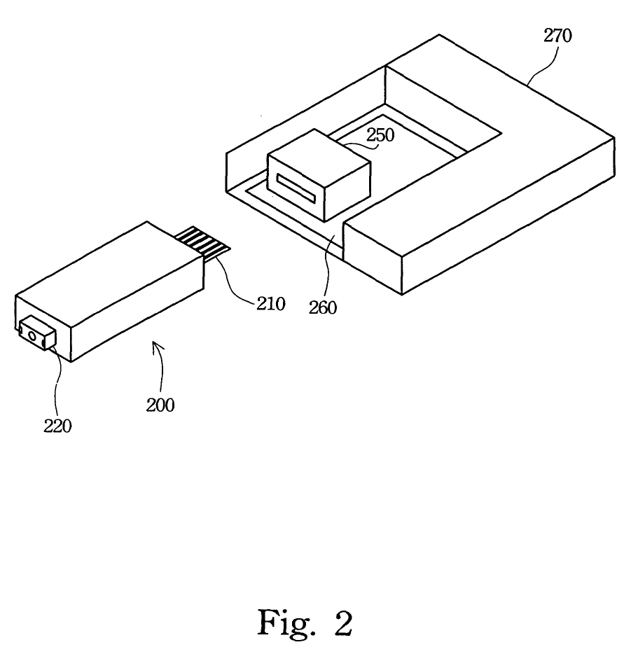

FIG. 2 is an optical transceiver module 200 installed in an electric appliance according to the present invention. The optical transceiver module 200 includes an optical fiber connecting interface 220 in front end thereof and a golden finger connecting interface 210 in rear end thereof. Between the optical fiber connecting interface 220 and the golden finger connecting interface 210, there is an optical transceiver of the optical transceiver module 200, or there is an optical transmitter for an optical transmitter module or an optical receiver for an optical receiver module. The optical transceiver module 200 with the golden finger connecting interface 210 can easily and quickly connect with a socket 250 on a printed circuit board 260 of an electric appliance 270. Because the present invention utilizes the golden finger connecting interface 210 to connect with the socket 250, the optical transceiver module 200 can be replaced by any type of optical transceiver module with the same of the golden finger connecting interface 210, anytime and anywhere. The user only needs to remove the original optical transceiver module from the socket 250 and plug a new optical transceiver module in the socket 250. Therefore, the optical transceiver module replacement process is finished and the electric appliance 270 can immediately work with the new optical transceiver module. The socket 250 includes a corresponding connecting interface which corresponds with the golden finger connecting interface 210. In general, the golden finger connecting interface 210 can be directly printed on a circuit board with conventional printed circuit board technology.

The pluggable optical transceiver module according to the present invention utilizes the same design specification to design and manufacture the golden finger connecting interface. Therefore, any different brand transceiver modules or different types of transceiver modules of the same brand are interchangeable if these transceiver modules follow the golden finger connecting interface requirement according to the present invention. When a pluggable optical transceiver module according to the present invention is damaged, the user may easily unplug the damaged module and insert a new one. Furthermore, if the appearance dimensions of the optical transceiver module are modified again, the optical transceiver module with the golden finger connecting interface according to the present invention is still interchangeable. Even if the optical communication specification is changed with each passing day, the pluggable optical transceiver module according to the present invention still provides a compatible optical transceiver module. The user may immediately change to any new optical transceiver module with the new communication specification and the same golden linger connecting interface so as to communicate with other equipment by way of optical signal transmission.

The pluggable transceiver module according to the present invention can be replaced by the user without any special tools so that the pluggable transceiver module is conveniently changed. In particular, an SSF single channel bi-direction optical transceiver module with the golden finger connecting interface according to the present invention can provide excellent compatibility. As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

While the foregoing is directed to embodiments of the present invention, other and further embodiments of the invention may be devised without departing from the basic scope thereof, and the scope thereof is determined by the claims that follow.

1. A pluggable optical transceiver module comprising:
an optical fiber connecting interface connecting with an optical fiber to transmit optical signals;
an optical signal transceiver connecting with the optical fiber connecting interface to transform the optical signals into electronic signals and in a reverse transformation; and
a golden finger connecting interface connecting with the optical signal transceiver to transmit the electronic signals.

2. The pluggable optical transceiver module of claim 1, wherein the golden finger connecting interface uses the printed circuit board technology to print golden fingers on a circuit board.

3. The pluggable optical transceiver module of claim 1, wherein the optical signal transceiver comprises an optical signal transmitter.

4. The pluggable optical transceiver module of claim 3, wherein the optical signal transmitter comprises a laser diode.

5. The pluggable optical transceiver module of claim 1, wherein the optical signal transceiver comprises an optical signal receiver.

6. The pluggable optical transceiver module of claim 1, wherein the optical signal receiver comprises a photo diode.

7. The pluggable optical transceiver module of claim 1, wherein the pluggable optical transceiver module further comprises a corresponding socket.

8. The pluggable optical transceiver module of claim 7, wherein the corresponding socket includes a corresponding interface corresponding to the golden finger connecting interface.

9. The pluggable optical transceiver module of claim 1, wherein the pluggable optical transceiver module comprises a single channel bi-direction small form factor optical transceiver module.

10. A pluggable single channel bi-direction small form factor optical transceiver module comprising:
an optical fiber connecting interface connecting with an optical fiber to transmit optical signals;
an optical signal transmitter connecting with the optical fiber connecting interface to transform output optical signals into output electronic signals and transmit the output electronic signals to the optical fiber connecting interface;
an optical signal receiver connecting with the optical fiber connecting interface to transform input optical signals into input electronic signals; and
a golden finger connecting interface connecting with the optical signal transmitter and the optical signal receiver to transmit the input electronic signals and the output electronic signals.

11. The pluggable single channel bi-direction small form factor optical transceiver module of claim 10, wherein the golden finger connecting interface uses the printed circuit board technology to print golden fingers on a circuit board.

12. The pluggable single channel bi-direction small form factor optical transceiver module of claim 10, wherein the optical signal transmitter comprises a laser diode.

13. The pluggable single channel bi-direction small form factor optical transceiver module of claim 10, wherein the optical signal receiver comprises a photo diode.

14. The pluggable single channel bi-direction small form factor optical transceiver module of claim 10, wherein the pluggable single channel bi-direction small form factor optical transceiver module further comprises a corresponding socket.

15. The pluggable single channel bi-direction small form factor optical transceiver module of claim 14, wherein the corresponding socket includes a corresponding interface corresponding to the golden finger connecting interface.

16. The pluggable single channel bi-direction small form factor optical transceiver module of claim 15, wherein the corresponding socket is mounted in a an electric appliance with the pluggable single channel bi-direction small form factor optical transceiver module.

17. The pluggable single channel bi-direction small form factor optical transceiver module of claim 10, wherein the pluggable single channel bi-direction small form factor optical transceiver module is about 0.5 inch wide.
